(19) United States
(12) Patent Application Publication
(10) Pub. No.: US 2005/0040158 A1
(43) Pub. Date: Feb. 24, 2005

(54) Heating conductor comprising a sheath

(76) Inventors: Jean-Pierre Bamy Bamy, Augsburg (DE); Jorg Penning, Kalletal (DE); Markus Walper, Odelzhausen (DE); Bernhard Gorlich, Puchheim (DE)

Correspondence Address: Robert P Renke;Artz & Artz, Suite 250, 28333 Telegraph Road, Southfield, MI, 48034, US

(21) Appl. No.: 10/497,599

(22) PCT Filed: Jul. 22, 2003
(86) PCT No.: PCT/DE03/02453

(30) Foreign Application Priority Data
Aug. 8, 2002 (DE) 102 36 554.7
Feb. 28, 2003 (DE) 103 09 207.2

(51) Int. Cl. H05B 3/34; H05B 3/54

(52) U.S. Cl. 219/549

(57) ABSTRACT

The invention relates to a heating conductor having a metallic conductor (2) and a jacketing (4) of plastic. The jacketing (4) can contain a thermally activable adhesive (6).

The present invention relates to a heat conductor according to the generic clause of claim 1.

### PRIOR ART

DE 3,703,939 discloses a heating element having a textile support attached thereto. This heating element is mounted on silicone paper with little stickers of self-adhesive film paper and then at its final service location. A disadvantage here is that many different materials are used, and handling is time-consuming.

DE 20117812 discloses a heating resistor attached to a support of temperature-activated adhesive. Here it is disadvantageous that an area much larger than actually necessary is coated with adhesive.

EP 1,049,355 discloses a heating conductor attached to a grid of fusion adhesive. This configuration is fixed to a support by large-area spraying on of a liquid adhesive. A disadvantage here is that at least two different adhesives are used.

### OBJECT OF THE INVENTION

The invention relates to a heating conductor having the features of claim 1. A heating conductor according to claim 1 makes possible an installation of the heating conductor with sparing use of adhesive, and without bringing persons in further processing of the heating conductor into contact with adhesive or liquid substances.

The features of claims 2 and 3 afford simple producibility with simultaneously fireproof service of the heating element.

The features of claims 4 and 5 ensure that breaches such as might occur in the adhesive jacket will not cause damage to surrounding parts, in particular surfaces of parts in contact.

The features of claims 6 and 7 afford adequate electrical insulation of the heating conductor from the user.

A heating conductor according to claim 8 is especially thin and flexible. Other advantageous conformations will be found in the additional claims.

### FIGURES

The description below deals with possibilities for conformation of the invention. This discussion is to be understood merely by way of example, and is given with reference to:

FIG. 1 Cross-section of a heating conductor.

FIG. 2 Top view of a heating conductor on a textile support.

FIG. 3 Portion of an area near the surface of an object to be heated, with a heating conductor in cross-section.

FIG. 4 Longitudinal section of an additional embodiment of the heating conductor according to the invention.

FIG. 5 Cross-section of an additional embodiment of the heating conductor.

### DESCRIPTION OF THE INVENTION

FIG. 1 shows a heating element 1. It has a metallic conductor 2. This is preferably produced from one or more strands of metal filament braided together.

The metallic conductor 2 is surrounded by a plastic jacketing 4. This jacketing 4, in the present example, is composed of one layer. This layer consists essentially of a thermally activable adhesive 6. By thermally activable, in this document, it is meant that the adhesive is sticky above an activation temperature and not sticky below said activation temperature, but will maintain existing adhesions. The adhesive is preferably a copolyamide. The adhesive is solid below a softening temperature. Even in the solid state, however, it is preferably soft and extensible, to avoid sharp edges in case of failure of the jacketing 4.

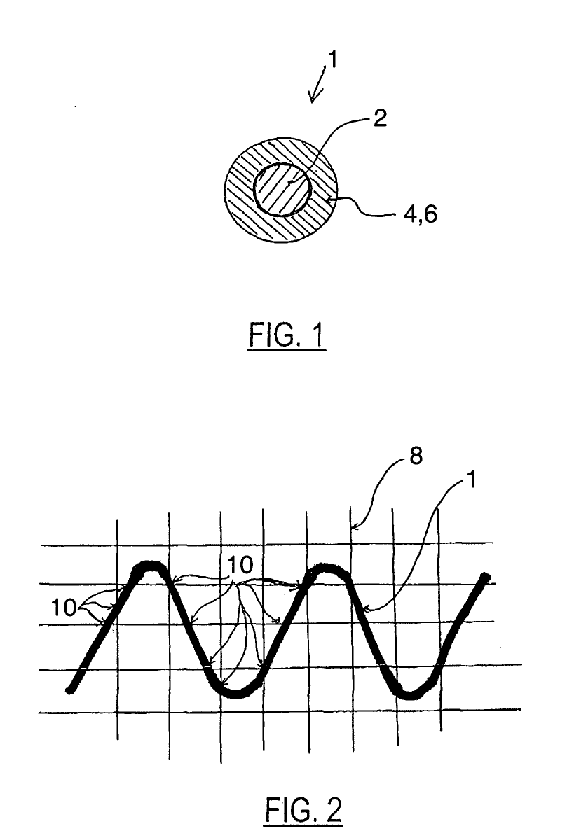

FIG. 2 shows a heating element 1 according to FIG. 1, undulantly fixed to a textile support 8. This fixation is effected preferably by the adhesive 6 of the jacketing 4. If it is intended to remove the support 8 again at the final place of service, it is advantageous for the heating element 1 to be connected to the support 8 partially only, namely in sub-areas 10. In the present embodiment by way of example, this is accomplished in that the support is a coarse-meshed textile. Hence, there are only partial contacts between the heating element 1 and the support 8. Such sub-areas 10 are arranged at each of the points of contact of heating element 1 and the fibers of the textile support 8.

Alternatively, however, the support might be a stamped or nubbed film or a fleece, in particular a pin fleece. The contacted sub-areas in the case of a fleece would be the fiber tips projecting from the surface of the fleece.

In the heating operation, an operating current flows from one end of the heating element 1 to its other end. The operating current is preferably so chosen that the heating temperature lies below the softening temperature of the adhesive 6. Alternatively, however, an adhesive that is volatilized at the heating temperature may be selected.

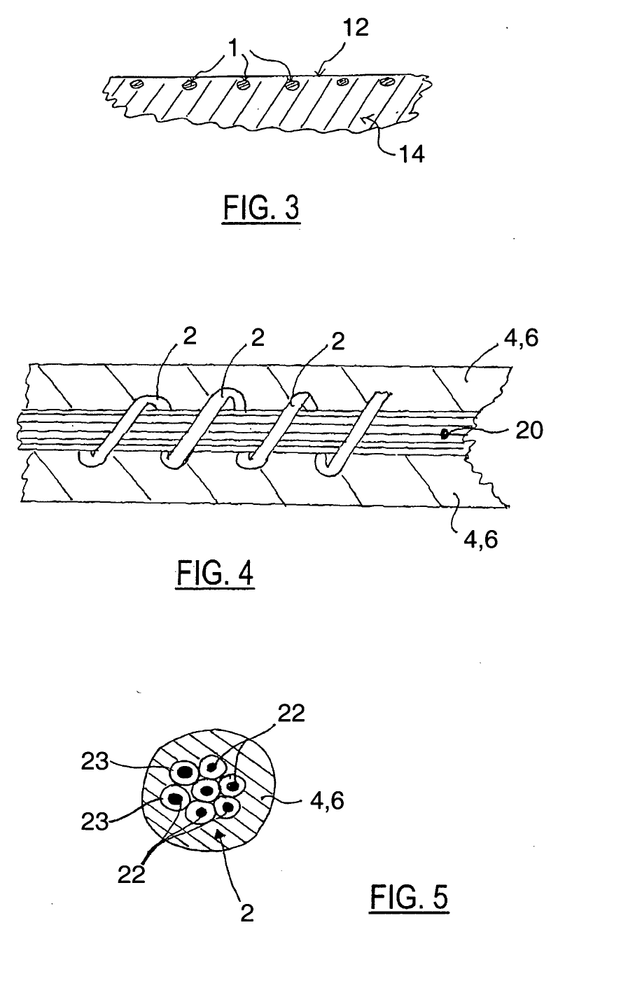

FIG. 3 shows an excerpt of a portion near the surface of a heated object. At a surface 12, for example of a vehicle seat, one or more heating conductors 1—shown in cross-section—are arranged. This arrangement may be of very flexible conformation under the present invention. In the present case, the heating element 1 is integrated into a foam pad arranged under the surface 12, for example by foaming in. Thus liquid foam is applied to the surface 12 and the heating element 1. The result is an embedding of the heating element 1 in the pad 14 near the surface, and an intimate, adhesive-free and air-permeable connection between surface 12 and pad 14. The support 8 may be foamed in at the same time or—as here—previously removed.

Alternatively, however, the heating conductors 1 may be laid directly on the surface 12. This can be accomplished by simply laying surface 12, heating element 1 and foam pad 14 one upon another.

In an embodiment not shown, the heating strands according to the invention might alternatively comprise a jacketing of two layers. A first, inner: layer serves for electrical insulation. A second, outer layer is of adhesive and serves to mediate adhesion between heating element and its surroundings.

The jacketing might alternatively comprise a non-homogeneous distribution of adhesive and insulating constituents. The non-homogeneously distributed insulating constituents then result in an insulating, irregular grid, distancing the conductor from its surroundings. The adhesive constituents yield a complementary adhesive grid fixing the conductor to its surroundings.

The conformation of the heating element of FIG. 4 comprises a relief strand 20. It is of flexible material, e.g. polyamide. The relief strand 20 may consist of one piece or of several parallel fibers joined together.

Spirally around the relief strand 20, a metallic conductor 2 is arranged. It is kept free from mechanical loads by the relief strand 20. It may therefore be optimized entirely for its heating function. The metallic conductor 2, therefore, according to the application, may have either a round or a flat, strip-like cross-section.

The apparatus of metallic conductor 2 and relief strand 20 is surrounded at least in part by an adhesive jacketing 4 as previously described.

The embodiment of the heating element of FIG. 5 comprises a metallic conductor 2 having a plurality of conductor strands 22.

At least some of the conductor strands 22, preferably all, are each jacketed individually by an electrically insulating sleeve 23. In the event of failure of a single conductor strand 22, this prevents local overheating at the failure location. For since the electric current carried by the damaged conductor strand cannot escape immediately at the point of failure to other conductor strands, the heating output of the defective conductor strand is distributed to the other conductor strands uniformly over the entire length of the heating conductor.

The metallic conductor 2, consisting of conductor strands 22, is surrounded as a whole by a jacketing 4. Alternatively, however, the metallic conductor 2 might be employed in an embodiment according to FIG. 4.

1. A heating conductor comprising a metallic conductor and a jacketing of plastic at least partially enveloping the metallic conductor, wherein at least a portion of the jacketing comprises a thermally activable adhesive.

2. A heating conductor according to claim 1, wherein said adhesive is a copolyamide.

3. A heating conductor according to claim 1, wherein said adhesive is solid below a softening temperature of less than 100° C. and a fusion temperature between 80° C. and 200° C.

4. A heating conductor according to claim 1, wherein the thickness of the jacketing is on average 0.2 mm or less.

5. A heating conductor according to claim 1, wherein the adhesive at ambient environmental temperatures, can be elongated more than 100%.

6. A heating conductor according to claim 1, wherein the adhesive is an electrical insulator imparting a breakthrough strength to the jacketing of the conductor of at least 12 V.

7. A heating conductor according to claim 1, wherein the jacketing comprises insulating material and adhesive.

8. A heating conductor according to claim 1, wherein the jacketing is a single layer.

9. A heating conductor according to claim 1, wherein the adhesive is repeatedly activable.

10. A heating conductor according to claim 1 comprising an areal support made of at least one of a fleece, textile, foam or perforated or nubbed film, the support carrying the metallic conductor and jacket assembly.

11. A heating conductor according to claim 10, wherein said heating conductor is fixed by the adhesive to the support.

12. A heating conductor according to claim 10, wherein the support comprises a surface adhesive at an ambient temperature of between −20° and +50° C.

13. A heating conductor according to claim 1, wherein the adhesive is adapted to volatilize to a large extent upon heating above a volatilization temperature or for a predetermined duration.

14. A heating conductor according to claim 1, wherein the heating conductor is arranged under the surface of a vehicle seat or steering wheel part in contact with a user.

15. A heating conductor according to claim 14, wherein the heating conductor is arranged in regions near the surface of a foam pad arranged under the contacted surface of the part.

16. A heating conductor according to claim 1 comprising a relief strand along a lengthwise axis, and wherein the metallic conductor is meanderingly arranged on said relief strand.

17. A heating conductor according to claim 1, wherein the metallic conductor comprises several conductor strands which are electrically insulated from each other.

18. A heating conductor comprising a metallic conductor at least partially enveloped by a plastic jacket, at least a portion of the jacket comprising a thermally activable adhesive which is a solid below a softening temperature of less than 100° C. and which, at ambient environmental temperatures, can be elongated more than 100%.

19. A heating conductor according to claim 18 wherein the adhesive is a single layer, electrical insulation imparting a breakthrough strength to the jacket of at least 12V.

20. A heating conductor according to claim 18 comprising a relief strand along a lengthwise axis, and wherein the metallic conductor spirally encircles the relief strand.

21. A heating conductor according to claim 21, wherein the metallic conductor comprises several conductor strands which are electrically insulated from each other.
